(19) United States
(12) Patent Application Publication
(10) Pub. No.: US 2008/0041976 A1
(43) Pub. Date: Feb. 21, 2008

(54) Servo-drive for actuating a fuel injection valve, including a cover for a contact system and/or sealing arrangement

(76) Inventor: Tim Bohlmann, Berlin (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/379,164

(22) Filed: Apr. 18, 2006

(30) Foreign Application Priority Data
Apr. 18, 2005 (DE) 10 2005 017 807.3

(51) Int. Cl. B05B 1/30

(52) U.S. Cl. 239/533.2

(57) ABSTRACT

A cover (10) is used as a protective covering for a contacting and/or sealing arrangement (3, 4) on a servo-drive (1) for actuating a fuel injection valve, wherein the cover (10) is easy to label, capable of being used in the greatest possible number of ways and has a cover body (12) in the form of a plastic injection molding with a labeling area (14) embedded in it. The plastic material of the cover body (12) is chosen for its suitability for laser welding to a fastening section (22) of the servo-drive (1), and the material of the labeling area (14) is chosen for its suitability for laser labeling purposes.

### CROSS-REFERENCE TO RELATED APPLICATIONS

This application claims priority from German Patent Application No. 10 2005 017 807.3, which was filed on Apr. 18, 2005, and is incorporated herein by reference in its entirety.

### TECHNICAL FIELD

The invention relates to the contacting and/or sealing of a servo-drive for actuating a fuel injection valve. In particular the invention relates to a servo-drive for actuating a fuel injection valve having a contact system and/or sealing arrangement together with the use of a cover for such a servo-drive or fuel injector.

### BACKGROUND

Such a contacting and sealing arrangement of a servo-drive is known from document DE 102 51 225 A1 for example. In order to create a permanent and in particular oil-tight seal between a piezoactuator of the servo-drive and an external contacting compression bond of the servo-drive, this prior art proposes inserting a fuel-resistant O-ring in the openings of a top plate surmounting the piezoactuator or its contact pins. In addition a sleeve of insulating material is inserted in each of the said openings, beneath the O-ring, providing centering and electrical insulation for the contact pin.

An example of a contacting arrangement for onward electrical connection of the contact pins of a piezoactuator using laterally projecting terminal pins of an external connection device is known from document DE 198 44 743 C1. Said publication discloses a device known as a “reed holder” having openings for the contact pins and having welded lugs arranged adjacent to the openings in such a way that they can be welded to the contact pins projecting through. The welded lugs on the reed holder are thus electrically connected to laterally projecting contact reeds, and can thus be used for the external connection of the complete fuel injector. According to the said prior art, after the contact pins have been welded to the welded lugs there is provision for a manufacturing step in which a plastic extrusion coating is applied to the upper surface of the reed holder.

The known injection molding of a contacting and/or sealing arrangement on a servo-drive is comparatively easy to perform and advantageously protects the underlying servo-drive components.

If a suitable plastic material is used it is also possible to consider labeling the finished injection molding externally by means of a laser.

Such labeling may include for example the type designation and/or serial number of the servo-drive and/or other information, such as the individual components built into the servo-drive, any of which may need to be subsequently read from the finished servo-drive. Said information may also include symbols or codes, such as a label known as a DMC (=“data matrix code”). Advantageously a code of this type is particularly machine readable. The labeling may for example contain information that is useful for traceability or traceback, for instance in the context of quality management, recall actions etc. (e.g. “traceability code”).

In the case of many common plastic materials it is easy to add labeling to the upper surface of the plastic extrusion coating with the aid of commonly available labeling lasers, since in the main such plastics have comparatively high optical absorption for the wave lengths concerned (typically in the infrared range), which means that the laser power can be placed to good effect on the surface of the plastic.

On the other hand, giving a final covering to a contacting and/or sealing arrangement on a servo-drive by means of a plastic extrusion coating also has disadvantages.

It turns out, for example, that the servo-drive components covered by the extruded plastic material frequently have to be formed in special ways (and at increased expense).

For instance in the case of the reed holder according to the said document DE 198 44 743 C1, a special seal is provided for the openings in the reed holder to prevent the intrusion of plastic during the injection molding procedure.

Quite separately from this, and particularly in the case of servo-drives having a piezoactuator, it also turns out that the service life of the actuator tends to be negatively affected by elements for sealing the actuator space and a final plastic extrusion coating on the contacting and/or sealing arrangement, which result in a more or less hermetic seal around the actuator.

### SUMMARY

A protective covering for a contacting and/or sealing arrangement on a servo-drive for actuating a fuel injection valve, can be formed in such a way that the said covering is easy to label and can be used for as many purposes as possible.

According to an embodiment, a servo-drive for actuating a fuel injection valve comprises a cover for a contact system and/or arrangement for sealing the servo-drive, wherein the cover has a cover body formed as a plastic injection molding with a labeling area embedded in it, the plastic material of the cover body is chosen for its suitability for laser welding to a fastening section of the servo-drive, and the material of the labeling area is chosen for its suitability for laser labeling purposes.

According to a further embodiment, the cover body can be largely in the shape of a disk. According to a further embodiment, an external peripheral edge of the cover body may have a lug projecting in axial direction on at least one point of the circumference. According to a further embodiment, the fastening section of the servo-drive can be formed from plastic. According to a further embodiment, the fastening section of the cover can be in the form of a plastic film. According to a further embodiment, the fastening section of the cover can be arranged on an outer surface of the cover. According to a further embodiment, the cover can be manufactured by means of a two-component injection molding method in which the labeling area is inserted into the injection molding tool.

According to another embodiment, a fuel injector may comprise a servo-drive for actuating a fuel injection valve, including a cover for a contact system and/or arrangement for sealing the servo-drive, the cover having a cover body formed as a plastic injection molding with a labeling area embedded in it, the plastic material of the cover body being chosen for its suitability for laser welding to a fastening section of the servo-drive, and the material of the labeling area being chosen for its suitability for laser labeling purposes.

According to yet another embodiment, a method of using a cover for covering a contacting and/or sealing arrangement on a servo-drive for actuating a fuel injection valve, the cover having a cover body formed as a plastic injection molding with a labeling area embedded in it, may comprise the steps of choosing the plastic material of the cover body for suitability for laser welding to a fastening section of the servo-drive, and choosing the material of the labeling area for suitability for laser labeling purposes.

### BRIEF DESCRIPTION OF THE DRAWINGS

The invention will be described in greater detail below with the aid of an exemplary embodiment and by reference to the accompanying figures. These show the following:

FIG. 1 A perspective view of a cover to be used as the external covering for the servo-drive for a fuel injection valve,

FIG. 2 A sectional view of the cover along the line II-II in FIG. 1,

FIG. 3 A perspective view to clarify the mounting of the cover on a servo-drive.

### DETAILED DESCRIPTION

According to an embodiment, a cover is provided to ensure that no special design is necessary for the contacting and/or sealing arrangement which it covers, and in particular that among other things no measures need be taken against the unwanted intrusion of liquid plastic. So that such a separately manufactured cover is not only easy to fasten in place but also easy to label, it is provided for the body of the cover to be formed as a plastic injection molding with a labeling area embedded in it, the plastic material of the cover body being chosen for its suitability for laser welding to a fastening section of the servo-drive, and the material of the labeling area being chosen for its suitability for laser labeling purposes. By at least partially embedding the cover section described as the “labeling area” by virtue of its suitability for laser labeling purposes, it is advantageously possible to ensure that the labeling stays on the cover permanently.

The labeling area can be preferably embedded at the same time as the cover body is manufactured, in such a way that at least one flat side of the labeling area makes close contact with the adjacent plastic material of the cover body.

However, it is not intended to exclude the possibility that the two sections may alternatively or in addition be joined together by some other method such as gluing or welding.

An embodiment provides for the cover body to be largely in the shape of a disk.

For many servo-drive designs the cover is fastened to the servo-drive more easily if an external peripheral edge of the cover body has an axially projecting lug or shoulder on at least one point of the circumference. It is at this point that the above-mentioned laser welding to a fastening section of the servo-drive could be performed.

An embodiment provides for the fastening section of the servo-drive to be formed from plastic.

The section of the servo-drive used for fastening the cover may be formed by a plastic extrusion on the circumference of the servo-drive, such as an injection molding which also provides a connector housing for externally connecting the servo-drive. In the case of servo-drives of the type concerned here, such a “connector molding” is frequently provided anyway in the axial upper end region on the external circumferential surface of a sleeve-shaped servo-drive housing, and is used to attach (or form) at least one component of the contacting and/or sealing arrangement of the servo-drive and at the same time to form a mechanical component of an electrical external connection device (such as a cable connector housing).

However, other components of the servo-drive and in particular components of the contacting and/or sealing arrangement can also be used as a fastening section.

When the fastening section of the servo-drive is made from plastic, then for the purpose of manufacturing both the fastening section and the cover body it is possible to make provision for plastic materials which mainly differ only by the proportion of their additives. In particular said additives can consist of dyestuffs such as pigments. The advantage of using additives in at least one of the two materials is that the optical properties of the materials can be set in a desired way, or “made to order” so to speak, and advantageously a single parent material can be used.

Lasers suitable for the labeling and welding of materials usually emit in the infrared range (e.g. Nd:YAG laser: 1064 nm) and are well known to prior art. Such lasers therefore need no further description.

In the matter of laser engraving of the labeling area, it is beneficial if the power of the labeling laser is absorbed by at least 90% after penetrating to a depth of only a few μm. Simple laser welding of the cover body to a fastening section of the servo-drive can be particularly well produced if for example the fastening section material possesses a similarly high absorption for the wavelength of the welding laser used, and if the cover body material transmits at least 90% of the welding laser power in the event that the laser beam used for this purpose must penetrate through the second cover body.

In general it may be preferable if the labeling area material has a greater absorption coefficient in the infrared than the cover body material and/or a lower transmission coefficient than the cover body material.

In an embodiment the labeling area is also formed from a plastic material. In this case for the purpose of simplifying the logistics of this material the difference between the plastic material of the cover body and/or the connector molding can as before be little more than the proportion of their additives.

The cover can be manufactured in a particularly simple way if the labeling area on the cover is in the form of a plastic film.

The cover can be manufactured in a particularly simple way by means of a two-component injection molding method in which the labeling area (e.g. film) is inserted into the injection molding tool. According to an embodiment the labeling area is first manufactured or assembled and the cover body is then formed from plastic in a plastic injection process. Even complicated designs can easily be produced by a manufacturing method of this kind.

The labeling area need make no contribution to the mechanical stability of the cover and can therefore be relatively thin. Preferably the average thickness of the labeling area may be in the range 5% to 50% of the average thickness of the cover (the averaging refers to the cover surface occupied by the labeling area).

According to an embodiment the labeling area does not extend beyond the total surface of the cover. In particular it is advantageous that the labeling area (which could for instance be circular or rectangular) extends over only a medium sized area of the cover surface, thus leaving enough space at the edge of the cover surface (which may for example be ring-shaped at the periphery) so that the laser beam from a laser provided for welding the cover to the fastening section can have unhindered access. The latter is beneficial for an embodiment in which the welding point between the cover and the fastening section is not accessible from outside because it is hidden after the cover is in place. In this case an advantageous embodiment provides for the cover body to be transparent in the infrared range and the fastening section to be strongly absorbing in the said infrared range, so that the welding laser beam can pass through the cover body without loss and reach the desired welding point.

According to an embodiment the labeling area is arranged on an outer side of the cover, that is with a flat side uncovered to the outside. An externally placed labeling area of this kind can be completely embedded in the cover body material, for example by means of a two-component injection molding method, by setting the labeling area as an insert directly onto a wall of the injection molding tool before the softened plastic material is injected. Arranging the labeling area on the outer side of the cover has the advantage of better suitability for labeling and subsequent legibility. However it is also possible to arrange the labeling area on the inner side of the body material or on the underside of the same. An advantage of such a “countersunk” arrangement of the labeling area is that the labeling is protected by the body material.

In the case of a servo-drive for actuating a fuel injection valve by means of a piezoactuator, an embodiment provides for the contacting and/or sealing arrangement to be permeable to gas. It turns out in practice that the service life of a piezoactuator used for actuating a fuel injection valve can be extended by “ventilating” the piezoactuator built into the servo-drive.

A possible explanation for the said extension to the service life or endurance of a piezoactuator by encouraging a gas exchange between the outside of the fuel injector and the actuator space is that if an actuator space is sealed as hermetically as possible, and in particular if it is as gas tight as possible, a partial vacuum is produced in the actuator space under certain operating conditions (such as during temperature fluctuations), allowing harmful substances (such as fuel, oil etc.) to reach the piezoactuator through the seal, which in practice cannot be made absolutely hermetic. Other possible explanations include for instance that after the manufacture of a hermetically sealed piezoactuator the concentration of any service-life shortening gas in the actuator space increases, or that filling the actuator space with air that is similar in composition to the atmosphere has a positive effect on the service life of the piezoelectric material.

Gas permeability of the contacting and/or sealing arrangement can be produced by incorporating for example a gas permeable elastomer material (such as silicone, in particular fluorosilicone) and/or a microporous material (such as expanded polytetrafluorethylene (ePTFE)). Such materials allow gas to be exchanged between the outside of the contacting and/or sealing arrangement and the actuator space, while at the same time excluding the fluid substances concerned.

An embodiment provides for the contacting and/or sealing arrangement to include an electrical connection device for the onward electrical connection of contact pins of an actuator, using terminal pins of an external connection device formed by the said connection device, and a hollow space to be provided between said connection device and the cover. Advantageously, such a hollow space is particularly useful for the ventilation of a piezoactuator when the seal being used is designed to be gas permeable.

The electrical connection device can in principle be produced according to a known type of reed holder (cf. for instance the above mentioned document DE 198 44 743 C1). For example the said connection device can include an electrically isolating plastic molded body surmounting the contact pins of a piezoactuator, containing openings to enable the contact pins to pass through, and supporting single-formed, electrically conducting connecting links, one of which is arranged at each of the openings, and which extend in each case from a contacting section adjacent to the associated opening as support for the contact pin which projects through, to one of several external terminal pins projecting laterally from the plastic molded body. The above-mentioned hollow space can be connected directly to the upper surface of such a plastic molded body, for example. For improved encouragement of the gas exchange it is beneficial if the connection device, such as the said plastic molded body, contains gas exchange passages.

The cover according to an embodiment can likewise contain gas exchange passages and/or form them in combination with the fastening section of the servo-drive concerned. For example an embodiment provides for the cover body to have passages linking the space under the cover to the exterior. Such passages can be comparatively small and/or labyrinthine in design, in order to reliably prevent the penetration of solid substances. When the servo-drive is being used for a fuel injector, which is flushed with motor oil on its side opposed to the injection valve during operation, such passages can allow the cover to be scoured with motor oil which can flow out again through the very same passages.

Manufacture of the servo-drive can include for example the following steps:
Manufacture of an axially extended servo-drive body, having a contacting and/or sealing arrangement, uncovered at one end, for an electrical actuator located in the servo-drive body,
Manufacture of a cover made from a laser-transparent plastic material, having embedded within it a labeling area which can be inscribed by laser and which does not completely occupy the surface of the cover,
Placement of the cover on the end of the servo-drive body, so that sections of the cover come into contact with sections of the servo-drive body,
Welding of the cover to the servo-drive body by means of a laser beam directed through the laser-transparent plastic material of the cover onto the contact point(s), and
Labeling of the cover by a laser beam directed onto the labeling area.

In summary the use according to an embodiment of a cover of the type described here for covering a contacting and/or sealing arrangement of a servo-drive for actuating a fuel injection valve in the corresponding embodiment offers in particular the following advantages:
The constructively simple, cost-effective and robust embodiment of a protective covering for the servo-drive or the fuel injector of which it is part
A covering which is simple to manufacture, for instance by a two-component injection molding method
The ability to use laser welding on the cover in order to fasten it to the servo-drive, at the same time having excellent suitability for laser labeling purposes (before or after fastening the cover)
The ability to guarantee the best possible “ventilation” of a piezoactuator contained in the servo-drive, thereby increasing the endurance life of the piezoactuator by choosing a suitable cover geometry
Formation of a mechanical protection for a servo-drive, in which motor oil can indeed wash over the contacting and/or sealing arrangement, but can flow out from there again. No final sealing step or injection molding step is necessary to protect the contacting and/or sealing arrangement.
The avoidance of penetration by solid objects into the area of the electrical contact system, thus improving the electrical operating reliability
The ability to make use of standard manufacturing methods for the cover (injection molding methods) and standard methods (such as lasers) for fastening and labeling the cover

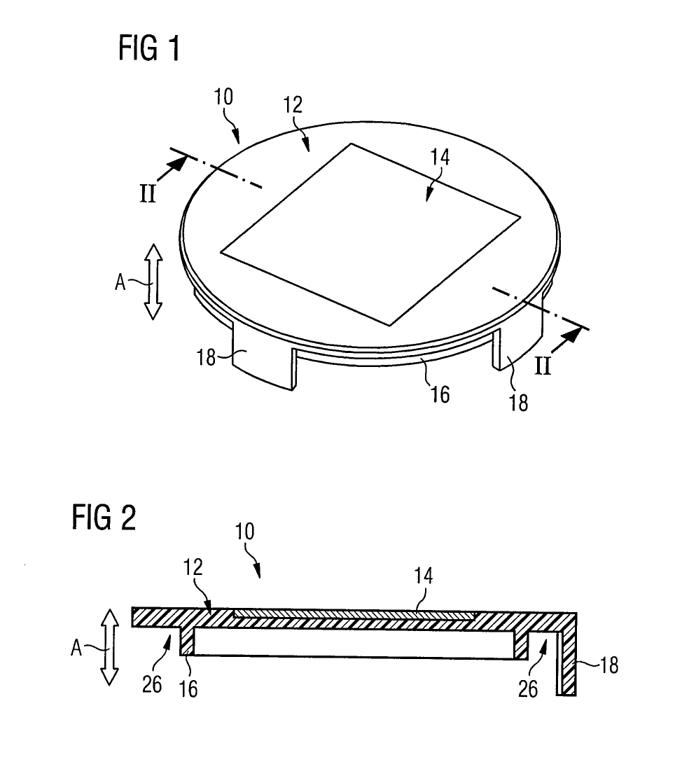

FIG. 1 shows a cover 10 which according to an embodiment is used as protective covering for a servo-drive.

The cover 10 has a cover body 12 formed as a plastic injection molding (in this case, Durethane AKV30H2.0LT904040) and, embedded on the upper surface, a labeling film 14 which was formed together with the cover body 12 by a two-component injection molding method on the cover 10.

The cover body 12 is in the form of a circular disk, such that an external peripheral edge has a lug projecting downward in an axial direction A in the form of a cover shoulder 16 together with three lugs or stops arranged around the circumference and likewise projecting downward, two of which can be seen in FIG. 1 and are designated 18.

FIG. 2 makes clear the arrangement of the relatively thin labeling film 14 on the upper surface or outer surface of the cover 10.

This labeling film 14 (in this case PA66, being Durethane AKV30H2.0901050LO) can be labeled by means of an infrared laser and is inscribed, before or after the cover 10 is mounted on the servo-drive, with a label called a data matrix code (DMC), containing information about among other things the components built into the servo-drive. For this purpose the beam from the labeling laser is directed from above straight onto the labeling film 14.

Around the rectangular labeling film 14 there remains a peripheral area of the cover body 12, through which the beam from a welding laser, likewise emitting in the infrared range, is directed in order to melt a fastening section of the servo-drive, which is adjacent to the cover body 12 when the cover is mounted, thus welding said fastening section to the cover 10. The plastic material of the cover body 12 possesses the necessary transparency in the infrared range (for example around 800 nm to 1200 nm) to allow the laser power to be applied to the smallest extent in the cover body 12 and to the greatest extent in the adjacent fastening section, which has a correspondingly higher absorption coefficient for this purpose. The incoming energy level, however, indirectly causes a more or less strong melting of the cover body in those areas which, when the cover is in position, are in direct contact with molten parts of the fastening section.

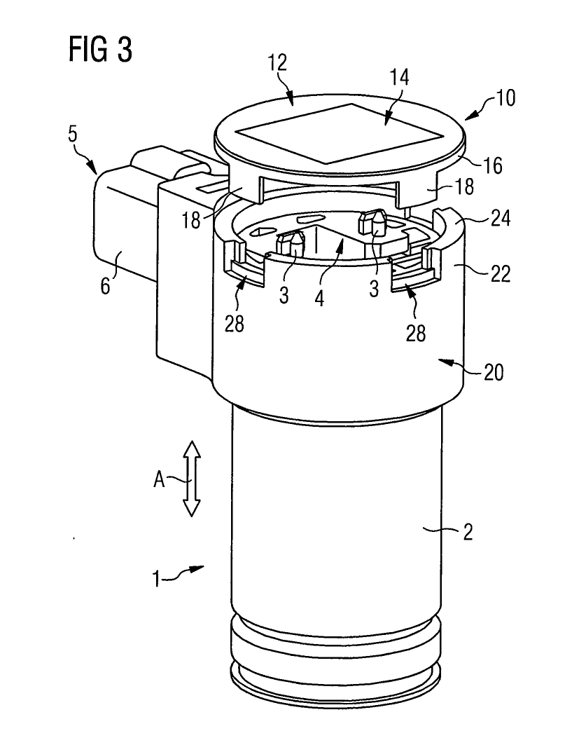

FIG. 3 clarifies the fitting of the cover 10 to a servo-drive 1 for actuating a (not shown) fuel injection valve in an internal combustion engine.

The servo-drive 1 comprises a metal, sleeve-shaped actuator housing 2, in which is positioned in a known way an electrical actuator (in this case a piezoactuator) for actuating a servo control valve connected upstream of the actual injection valve. All that can be seen of the piezoactuator in FIG. 3, projecting upward from an axial opening in the housing 2, are the contact pins 3 which are electrically connected to contact reeds of an external connector 5 by means of a reed holder 4 which is opened from above. This onward electrical connection of the piezoactuator contact pins or the design of the reed holder 4 corresponds in this case mainly to the prior art according to the document DE 198 44 743 C1 mentioned originally. In contrast to this prior art, however, in the servo-drive 1 shown, no final plastic extrusion coating is provided to protect the contact arrangement (reed holder 4) and the underlying arrangement for sealing. For this purpose the cover 10 is instead placed in position from above (see arrows) and subsequently fastened to the servo-drive 1. FIG. 3 shows further a plastic item known as a connector molding 20, which encases an upper end region of the sleeve-shaped actuator housing 2 and has a projecting shoulder 22 which stands up in axial direction A.

The connector molding 20 serves in the first instance to fix the reed holder 4 in its mounted position relative to the actuator housing 2, shown in FIG. 3, and to form a cable connector housing 6 with a laterally projecting section.

In addition the connector molding 20 of the illustrated servo-drive 1 or the shoulder 22 has the function of a fastening section for firmly linking the cover 10 to the servo-drive 1.

This fastening section or fastening shoulder 22 has on its side facing toward the cover 10 a linking surface 24 which enters into flush contact with a corresponding linking surface 26 (FIG. 2) of the cover 10 after the cover 10 has been put in position.

When the cover 10 is put in position the external peripheral surface of the cover shoulder 16 also makes contact with flat areas of the internal circumference of the fastening shoulder 22 with at worst very slight play.

When the cover 10 is in position, the beam from an infrared laser is directed from above through the laser-transparent cover body material onto the laser-absorbent linking surface 24 of the fastening shoulder 22, causing the plastic material of the connector molding 20 to melt at this spot and to be welded to adjacent sections of the cover (flat areas 26). In this way the cover 10 for protecting the contacting and/or sealing arrangement of the servo-drive 1 located a certain distance below is indissolubly linked to the servo-drive 1.

The cover shoulder 16 not only contributes to positioning or centering the cover 10 during placement on the connector molding 20, but also has an advantageous effect during the welding process. The greater of lesser closeness of the cover shoulder 16 to the inner side of the fastening shoulder 22 prevents molten plastic material from penetrating into the space covered by the cover 10. In a departure from the exemplary embodiment shown, the cover shoulder 16 could have one or more breaks in its contour. The said protection from penetration by molten plastic material requires this shoulder to be present only in those areas along the circumference where material is melted.

In the exemplary embodiment shown, the contour of the fastening shoulder 22 on the connector molding 20 is broken in three places by a ventilation cutout 28, the arrangement of which in the circumferential direction corresponds to the arrangement of the stops 18 projecting downward from the cover body 12. When the cover 10 is put in position on the connector molding 20, shoulders 16 reach a position which almost completely closes the ventilation cutouts 28. However, a small gap remains between the edge of each stop 18 and the edge of the ventilation cutout 28 concerned, so that by means of these gaps a considerable gas exchange is advantageously enabled between a hollow space covered over by the cover 10 and the exterior (installation environment).

The ventilation passages formed from a combination of the stops 18 and the cutouts 28 are designed to be “labyrinthine” in the servo-drive 1 shown, so that in the event of comparatively large gas exchange volumes, the intrusion of solid objects into the covered hollow space is reliably avoided. Moreover the ventilation passages are designed so that when the servo-drive 1 is operating any fluid substances such as motor oil that might flow into these passages in the servo-drive can also flow out again from the servo-drive 1. In order to eventually make the ventilation of the hollow space above the ventilation passages usable for effective ventilation of the piezoactuator located in the actuator space, the reed holder 4 and a sealing arrangement (not shown) located underneath are designed to be gas permeable. The gas permeability of the seal is mainly derived from the fact that a corresponding sealing element is formed from a fluorosilicone material with comparatively high gas permeability. This results in a good seal against liquids at the same time as an advantageously high permeation rate for gaseous substances.

In the exemplary embodiment shown, a high gas exchange volume between the covered hollow space on the upper surface of the reed holder 4 and the arrangement for sealing located under the reed holder 4 is encouraged by ventilation passages which pass through a plastic,body of the reed holder 4 in axial direction A.

In summary the cover 10 provides a covering which can be easily manufactured, labeled and fastened, for protecting components of an injection drive. The cover 10 can be manufactured in a particularly simple way by means of film back-injection technology. In the exemplary embodiment described, the transmission properties of the plastic material to be back-injected are not the same as those of the plastic used for the connector molding 20. The cover body material is laser-transparent, whereas the connector molding is comparatively strongly absorbing for the LASER wavelengths used in welding. The excellent suitability of the cover 10 for labeling (before or after it has been fitted) is ensured by a comparatively thin plastic area which can be inscribed by laser technology, in particular by using a labeling laser at a wavelength that is at least in approximately the same wavelength range (e.g. infrared range). By means of an appropriately optimized choice of material or material modification (e.g. by mixing dyestuffs) it is even conceivable in principle to use one and the same wavelength for the laser welding and the laser labeling. In this case it is even possible to use one and the same laser first to fasten the cover and then (possibly in a single processing step) to perform the labeling in the same processing station.

1. A servo-drive for actuating a fuel injection valve comprising a cove for a contact system and/or arrangement for sealing the servo-drive, wherein the cover has a cover body formed as a plastic injection molding with a labeling area embedded in it, the plastic material of the cover body is chosen for its suitability for laser welding to a fastening section of the servo-drive, and the material of the labeling area is chosen for its suitability for laser labeling purposes.

2. The servo-drive according to claim 1, wherein the cover body is largely in the shape of a disk.

3. The servo-drive according to claim 1, wherein an external peripheral edge of the cover body has a lug projecting in axial direction on at least one point of the circumference.

4. The servo-drive according to claim 1, wherein the fastening section of the servo-drive is formed from plastic.

5. The servo-drive according to claim 1, wherein the fastening section of the cover is in the form of a plastic film.

6. The servo-drive according to claim 1, wherein the fastening section of the cover is arranged on an outer surface of the cover.

7. The servo-drive according to claim 1, wherein the cover is manufactured by means of a two-component injection molding method in which the labeling area is inserted into the injection molding tool.

8. A fuel injector, comprising a servo-drive for actuating a fuel injection valve, including a cover for a contact system and/or arrangement for sealing the servo-drive, the cover having a cover body formed as a plastic injection molding with a labeling area embedded in it, the plastic material of the cover body being chosen for its suitability for laser welding to a fastening section of the servo-drive, and the material of the labeling area being chosen for its suitability for laser labeling purposes.

9. A method of using a cover for covering a contacting and/or sealing arrangement on a servo-drive for actuating a fuel injection valve, the cover having a cover body formed as a plastic injection molding with a labeling area embedded in it, the method comprising the steps of:
choosing the plastic material of the cover body for suitability for laser welding to a fastening section of the servo-drive, and
choosing the material of the labeling area for suitability for laser labeling purposes.

10. The method according to claim 9, wherein the cover body is largely in the shape of a disk.

11. The method according to claim 9, wherein an external peripheral edge of the cover body has a lug projecting in axial direction on at least one point of the circumference.

12. The method according to claim 9, further comprising the steps of forming the fastening section of the servo-drive from plastic.

13. The method according to claim 9, wherein the fastening section of the cover is in the form of a plastic film.

14. The method according to claim 9, wherein the fastening section of the cover is arranged on an outer surface of the cover.

15. The method according to claim 9, comprising the steps of manufacturing the cover by means of a two-component injection molding method in which the labeling area is inserted into the injection molding tool.
